(19) United States
(12) Patent Application Publication
(10) Pub. No.: US 2007/0294292 A1
(43) Pub. Date: Dec. 20, 2007

(54) ADVERTISING TRANSFER AND PLAYBACK ON PORTABLE DEVICES

(75) Inventors: Aamer Hydrie, Seattle, WA (US); Eduardo P. Oliveira, Redmond, WA (US); Gareth Alan Howell, Bothell, WA (US)

Correspondence Address: SENNIGER POWERS (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/424,215

(22) Filed: Jun. 14, 2006

(51) Int. Cl. G06F 17/00

(52) U.S. Cl. 707/104.1

(57) ABSTRACT

Managing predetermined media content in connection with rendering selected media content on a portable computing device. A client application executed on the portable computing device specifies a predetermined media file to be rendered in connection with a selected media file. The client application tracks the rendering of the predetermined media file and, upon synchronization to another computing device, reports the results of the tracking to the other computing device. The computing devices communicate according to a media transfer protocol. In an alternative embodiment, the other computing device transfers the predetermined media file to the portable computing device in a playlist.

### BACKGROUND

Conventional delivery of video programming involves distributing video content to users via terrestrial, cable, and satellite systems. With the advent of faster Internet connection speeds and greater bandwidth, increasing numbers of users access video content online. Video on demand systems allow users to access video content over a global communications network, such as the Internet, and watch selected content on their computers, portable computing devices, and the like. Typical video on demand, or online video, services stream this video content to users over the network for viewing while the video is being transferred to their computing devices.

Much like conventional video delivery, advertising provides a major source of revenue for online video services. These online services often provide short streaming video clips with advertisements inserted at the beginning of the desired video content. Because the video stream is generated at the website's server, the online video service can exercise full control over the insertion of video ads into the stream. Moreover, the user cannot circumvent watching streaming video ads because their insertion is server-based.

A major limitation on streaming video is that the quality of the video content is limited by the bandwidth of the user's connection. This bandwidth can be quite constrained and, thus, the video quality tends to be limited. Recently, some video content providers allow users to download video content for viewing on their computing devices after completion of the download. In addition to allowing offline viewing, downloading a video file in its entirety to the user's computing device allows the user to obtain higher quality video content and, thus, improves user experience.

Although downloading video content can provide certain advantages over streaming video, it presents problems in managing ad delivery and insertion. For example, the nature of downloading content dictates that many users will desire to view content while offline. Moreover, ads that are inserted locally are much more vulnerable to circumvention by the user so the mechanism used to insert ads must be immune to circumvention by the user. Thus, a mechanism for managing advertising for a download video service that is operable for offline viewing is also desired.

In addition, many users desire to have downloaded media content rendered on their portable computing devices. Unfortunately, the problems associated with ad insertion and management for downloaded video and the like are compounded in the portable device environment. For example, portable devices are often not online, which makes rotating ads and enforcing their playback more difficult. Also, when portable devices are offline, it becomes difficult to accurately track and report on ad playback.

### SUMMARY

Embodiments of the invention overcome one or more deficiencies in known online video services and media player systems by managing the delivery of advertisements and other predetermined media content in connection with downloaded media content rendered on a portable computing device. Aspects of the invention involve executing a client application on a local computing device to support ad functionality on a portable computing device. Advantageously, the local client caches ad reports, impressions, and the like locally and provides an ad playlist to the portable device upon synchronization. In this instance, the local client sends the ads or other predetermined media content with the selected media content to the portable device in the playlist. This occurs when the portable device is synchronized with the local device. The local device may maintain a cache of ads in a format for rendering locally and in a format for rendering on the portable device, or may transcode the ads for rendering on the portable device.

In the alternative, aspects of the invention involve executing a client application on the portable computing device. Advantageously, the portable device client permits caching predetermined media content directly on the portable device. The cache may be refreshed through synchronization or through a direct network connection. In this instance, the portable device client may also contain business logic for ad tracking, reporting, and the like.

Computer-readable media having computer-executable instructions for managing ad playback on a portable device in connection with downloaded video embody further aspects of the invention. Alternatively, embodiments of the invention may comprise various other methods and apparatuses.

Other features will be in part apparent and in part pointed out hereinafter.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating one example of a suitable computing system environment in which aspects of the invention may be implemented.

FIG. 2 is an exemplary block diagram illustrating communications between a computer and an associated portable device according to aspects of the invention.

FIG. 3 is an exemplary block diagram illustrating a content delivery and playback system for a portable device according to aspects of the invention.

FIG. 4 is an illustration of an exemplary playlist according to aspects of the invention.

FIG. 5 is an exemplary block diagram illustrating a content delivery and playback system for a portable device according to further aspects of the invention.

Corresponding reference characters indicate corresponding parts throughout the drawings.

### DETAILED DESCRIPTION

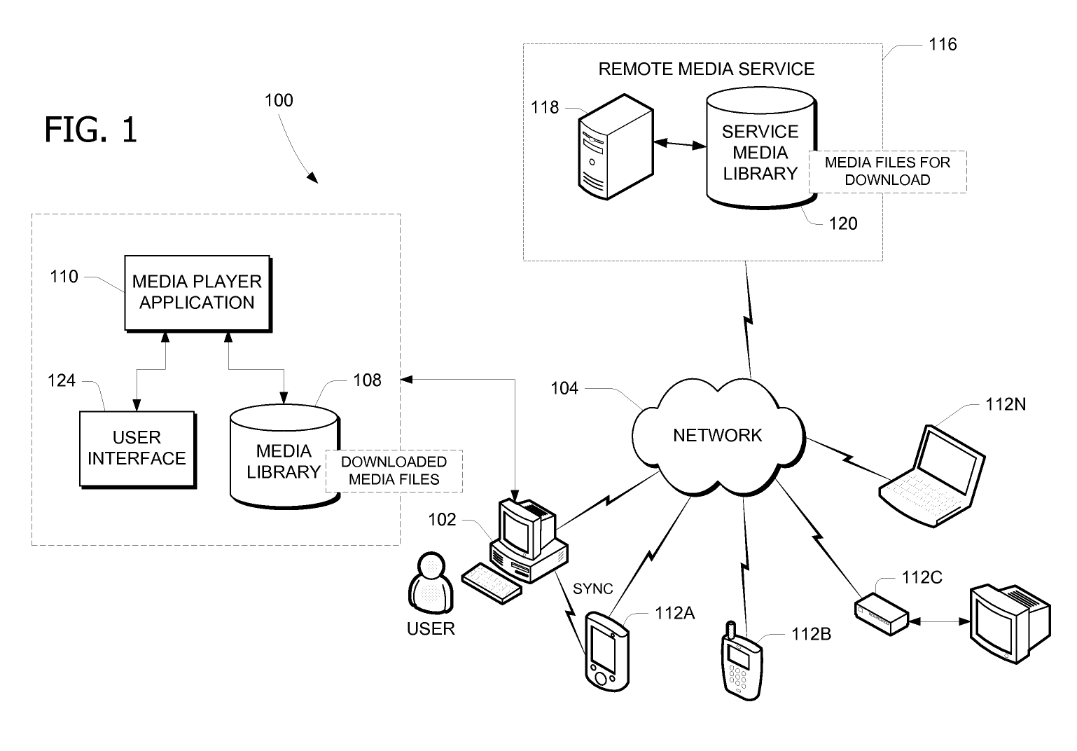

Referring now to the drawings, FIG. 1 illustrates an exemplary computing environment for a download media content service in which embodiments of the present invention may be implemented for managing predetermined media content, such as advertisements, on a portable computing device. As described in detail below, aspects of the invention execute a client application to support ad functionality on the portable computing device in connection with the rendering of selected media content. Advantageously, the client caches ad reports, impressions, and the like. In one embodiment, a local client provides a playlist to the portable device upon synchronization to specify when and what predetermined media content is rendered on the portable device. In an alternative embodiment, the portable device executes a client application that supports ad functionality.

In FIG. 1, a media system 100 includes one or more client computing devices such as a computer 102 coupled to a data communication network 104. As an example, network 104 is the Internet (or the World Wide Web) but aspects of the present invention may be applied to any data communication network. The user's computer 102 can access one or more digital media files stored locally in the form of, for example, a local media library 108. The local media library 108 may reside on the computer's hard drive, a removable computer-readable storage medium, or the like. In the illustrated embodiment, computer 102 executes a playback engine, such as a media player application 110, for rendering selected media files from local media library 108. Those skilled in the art are familiar with such software routines that, when executed by a computer, render media content and retrieve, store, and display contextual information. The media player application 110 may be any suitable media player that is configured to play digital media so that a user can experience the content that is embodied on the media. For example, a media player application embodying aspects of the invention may be built on Microsoft Corporation's Windows Media™ Player program.

According to aspects of the invention, a portable computing device 112 also executes media player application 110, or a reduced version of media player application 110, for rendering media content. The portable computing device 112 may be a PDA 112A, mobile phone 112B, network media player or gaming system 112C (and associated monitor), laptop computer 112N, or the like. In this instance, portable computing device 112 may also maintain its own media library 108 containing media content files for rendering thereon. Although illustrated as communicating via network 104, it is to be appreciated that a number of wired and wireless network formats are available to enable communication between local computer 102 and the remote portable computing device 112. For example, portable computing device 112 and local computer 102 may be connected via a USB connection, Bluetooth, or a wireless network connection. Moreover, those skilled in the art are familiar with synchronizing content and information between computing device 102 and computing device 112.

Referring further to FIG. 1, aspects of the invention also include communication between the media player application 110 executed on computer 102 (or on the remote portable computing device 112) and one or more remote media services 116. For example, the remote media service 116 is an online video or video on demand service that provides video content such as television programs, movies, video clips, and the like for downloading and viewing by the user. Those skilled in the art are familiar with such services from which a user may download media files and/or stream them via the Internet, usually for a monthly subscription price or on a per-file basis. For example, the service media library contains the inventory of the online media content provider.

In one embodiment, an online media content provider such as remote media service 116 utilizes one or more servers 118, also coupled to the network 104. The remote media service 116 includes a memory area, illustrated here as a database 120 associated with server 118. The remote media service 116 maintains a catalog of available media files, that is, a remote service media library, in database 120. The computer 102 (or remote computing device 112) may access the server 118 (and the information in the database 120) via network 104. For instance, the digital media files in media library 108 contain video or other media content downloaded from database 120 and adapted for rendering on computer 102. Server 118 and computer 102 communicate in the illustrated embodiment using, for example, the hypertext transfer protocol (HTTP). It is to be understood that remote computing device 112 may also access server 118 through computer 102 or directly via network 104.

As described above, the system 100 of FIG. 1 permits the user to render a downloaded media file on an enabled media playing device (e.g., computer 102 or portable device 112 running a version of Microsoft® Windows® operating system and a version of Windows Media™ Player program). A user interface 124 associated with media player application 110 communicates information to the user and receives instructions and feedback from the user. In one embodiment, media player application 110 is responsive to user input via the user interface 124 for selecting media content from remote media service 116 for downloading to computer 102 and performing one or more media player operations. In addition to playback or transport controls, typical media player operations include, for example: displaying metadata associated with the media files; rendering, copying, or downloading selected media files; rendering samples of selected media files; assigning media files to one or more playlists; searching or sorting the media files according to their metadata or content; displaying media library contents; scrolling through the media library contents; and displaying contextual menus of available media player operations. Other user interfaces different from those described above are contemplated as within the scope of the claimed invention. Those skilled in the art are familiar with a variety of input devices that may be connected to computer 102 for receiving input via user interface 124.

Although described primarily in the context of video media files, aspects of the invention may be applied to various forms of digital media, including video and multimedia files (e.g., movies, movie trailers, television shows, etc.), audio files (e.g., music tracks, news reports, audio web logs, audio books, speeches, comedy routines, etc.), media broadcasts (e.g., webcasts, podcasts, audiocasts, videocasts, video blogs, blogcasts, etc.), and images.

The media system 100 implements ad management in accordance with aspects of the invention. As described above, computer 102 executes media player application 110 for rendering one or more media files. In this instance, media library 108, which may be stored on the hard drive of computer 102 or a removable storage device associated with the computer, contains one or more media files. In addition, remote library 120 contains one or more media files. Although library 120 is remote from computer 102, its media files are accessible by media player application 110 via network 104. The system 100 operates on one or more media items selected from a collection or multiple collections (e.g., library 108 and/or library 120) of media items selected for consumption by the user. Although sometimes referred to as a playback, it is to be understood that media player application 110 may render media files not only by playing but also by other means (e.g., viewing, accessing, etc.). Selected media files may be further downloaded from computer 102 to portable computing device 112 (or downloaded directly from remote media service 116 via network 104) for rendering remotely. In one embodiment, portable computing device 112 implements MTP (Media Transfer Protocol) available from Microsoft Corporation for transferring media files and their associated metadata back and forth between computer 102 and portable computing device 112.

One of the challenges of synchronizing video to portable device 112 is the fact that device content usually needs to be encoded at a lower resolution than content rendered on local computer 102. In one embodiment, relatively higher resolution video files for computer 102 are transcoded into device-friendly, lower resolution files during synchronization. Because the transcoding process may slow down the sync process and may not support digital rights management, an alternative embodiment seamlessly delivers a device-friendly file along with the primary media file. In this instance, the device file is associated with the primary file within media player application 110. At sync time, this device file is synchronized transparently instead of the primary file.

Although described in connection with an exemplary computing system environment, aspects of the invention are operational with numerous other general purpose or special purpose computing system environments or configurations. The computing system environment is not intended to suggest any limitation as to the scope of use or functionality of aspects of the invention. Moreover, the computing system environment should not be interpreted as having any dependency or requirement relating to any one or combination of components illustrated in the exemplary operating environment. Examples of well known computing systems, environments, and/or configurations that may be suitable for use in embodiments of the invention include, but are not limited to, personal computers, server computers, hand-held or laptop devices, multiprocessor systems, microprocessor-based systems, set top boxes, programmable consumer electronics, PoP devices, mobile telephones, network PCs, minicomputers, mainframe computers, distributed computing environments that include any of the above systems or devices, and the like.

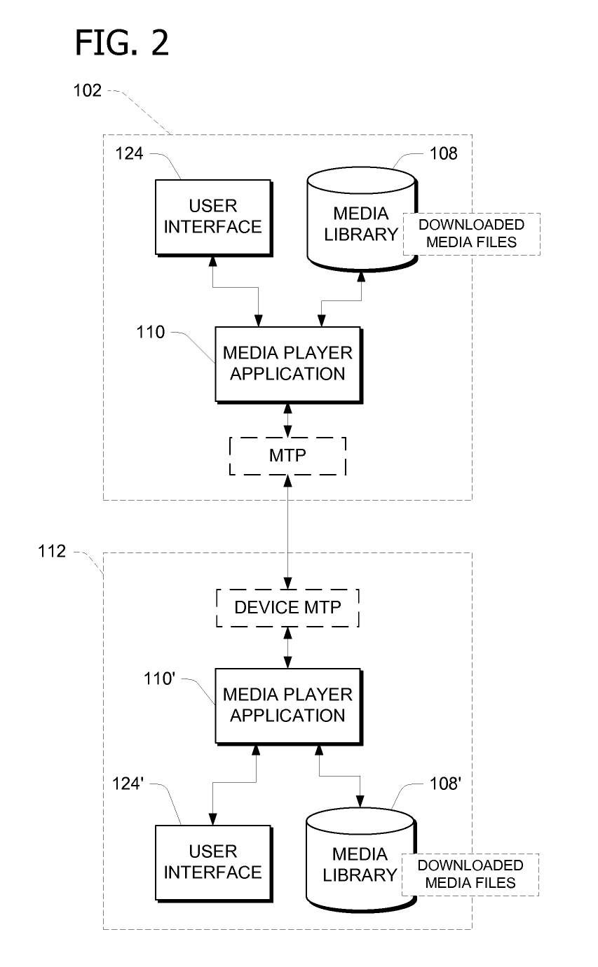

Referring next to FIG. 2, a block diagram illustrates an exemplary implementation for performing client-based ad management. As shown, computer 102 and portable computing device 112 implement a protocol such as MTP for transferring media files and their associated metadata back and forth between the two. In the illustrated embodiment, portable computing device 112 executes media player application 110′ for rendering media files contained in its media library 108′. The user provides input and receives information regarding the operations of media player application 110′ via user interface 124′.

Advantageously, MTP permits enumerating, reading, and writing files. In addition, computer 102 and portable device 112 exchange metadata via MTP, transfer licenses or tokens for establishing user rights and enforcing ad playback, and permit custom commands to be defined. These functions are available when docking portable device 112 or otherwise connecting it to computer 102. In this manner, aspects of the present invention track the number of times either computer 102 or portable device 112, or both, renders a particular media file and overcome problems caused by the portable device 112 being offline or caused by the sync infrastructure itself.

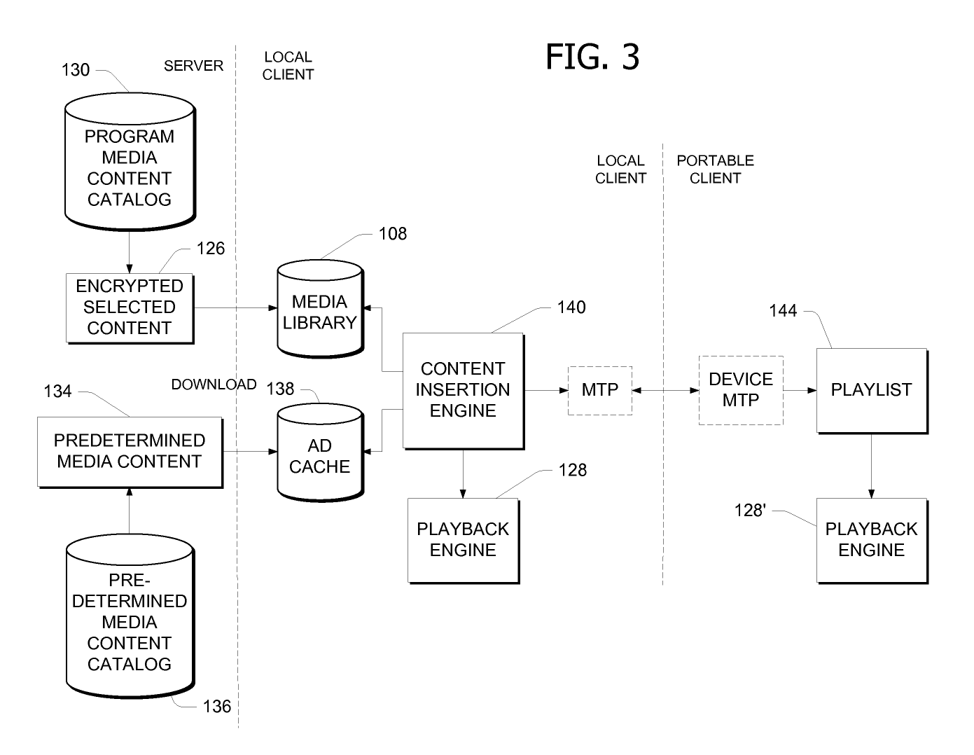

Referring next to FIG. 3, a block diagram shows an exemplary manner in which media system 100 performs client-based ad insertion and reporting. A content insertion and enforcement process embodying aspects of the invention begins when the user selects a content file 126 for downloading and rendering by a playback engine 128 (e.g., media player application 110). The user may select the content file 126 from a catalog of available program media content 130 (e.g., the remote service library of database 120) available for download via remote media service 116. In one embodiment, this selected content file 126 is encrypted in a manner such that a plug-in or the like can prevent it from being played until certain conditions are met.

In addition to the selected media content 126, one or more predetermined media content files 134, such as video advertisements, are also downloaded to the user's computer 102 from a library or catalog 136 of available ads or other predetermined media content (e.g., the remote service library of database 120) for rendering via playback engine 128. The ads may be randomly selected or targeted based on, for example, user information, or targeted based on the selected content. As shown in FIG. 3, system 100 stores one or more predetermined content files 134 locally in an ad cache 138 for subsequent rendering in connection with selected content file 126. The cache 138 may be maintained on computer 102 in both PC and device format. In an alternative embodiment, the PC clients transcodes the ads before sending them to the portable device 112.

In one embodiment, the local computer 102 executes computer-executable instructions implementing a client application in the form of a content insertion engine 140. The content insertion engine 140, as shown in FIG. 3, is responsible for selecting predetermined content file 134 for playback and for scheduling its playback at an appropriate time. As an example, the content insertion engine retrieves the predetermined content file 134 from ad cache 138. Advantageously, predetermined media content 134 is separate from selected media content 126 in one embodiment so that it may be changed according to an ad rotation schedule or otherwise targeted to a particular use.

Once the content downloads are complete, the selected media content file 126 becomes available for decrypting and rendering by the playback engine 128. When the user selects the downloaded content for playback, an event is raised to the content insertion engine 140. In response to this event, content insertion engine 140 retrieves predetermined content file 134 from the ad cache 138 and sends it to playback engine 128 for rendering or otherwise instructs playback engine 128 to begin its playback.

According to aspects of the invention, a client application such as content insertion engine 140 executed by local computer 102 also supports ad functionality on the portable device 112. Although illustrated separately, it is to be understood that this client application may also implement playback engine 128 for rendering media content on computer 102. Augmenting the client application at computer 102 as contemplated herein supports ad delivery, insertion, and reporting on portable device 112 with minimal changes to the device 112. In other words, the local computer client does not require porting the business logic of the ad client to the portable device 112. Moreover, the client acts as a single aggregator on computer 102 for ad report caching and impressions. Thus, portable device 112 is not required to maintain a cache of ads on its relatively limited storage.

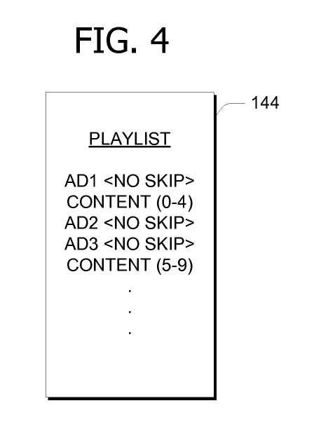

In one embodiment, content insertion engine 140 (i.e., a PC ad client) provides, at sync time, a list of ads or other predetermined media content files 134 to play with selected media content 126 for portable device 112. Those skilled in the art are familiar with existing mechanisms to select the particular ads to be shown (e.g. an ad manifest). The local computer sends both predetermined media content 134 and selected media content 126 to portable device 112 in a form resembling a playlist 144 (see FIG. 4). The playlist 144 may be refreshed whenever portable device 112 is synchronized, which allows the ad client, content insertion engine 140, to perform ad rotation and to track ad expiration. Although illustrated as a single application, it is to be understood that content insertion engine 140 may be implemented by a separate ad plug-in and ad insertion engine. The ad plug-in encapsulates the logic for selecting predetermined media content 134 for playback within a specific video or other media file 126. The ad plug-in may base its decisions on numerous factors, including content category, user age, user location, and user gender. The ad plug-in also tracks playback to prevent undesired multiple renderings of the same ad. In addition to ad targeting, the ad plug-in is also responsible for keeping the local ad cache 138 fresh. The ad insertion component of content insertion engine 140 is responsible for inserting ads during playback of the selected media content file 126.

It is to be understood that one or more ads or other predetermined media content files 134 may be scheduled for playback at any time relative to playback of selected media content file 126 (e.g., as bumper ads, interstitial ads, or both). In the context of audio files, for example, predetermined ad entry points may occur at selected song boundaries to enable a listening experience similar to radio.

The ad insertion component of content insertion engine 140 implements a state machine, for example, that runs in a background thread within media player application 110 and relies on the player's object model to monitor playback and insert ads. The insertion engine 140 may also incorporate anti-tampering measures to prevent users from bypassing ads. For example, the client may enforce playback by disabling the transport controls of media player application 110 or simply requiring playback for a certain amount of time (e.g., the duration of an ad being played). This effectively negates the benefits of skipping or fast forwarding through the ad.

Advantageously, aspects of the invention provide an enforcement mechanism for ensuring that advertisements and other predetermined content may not be circumvented by the user when such files are downloaded to the user's computer 102. This enforcement mechanism deters the user from skipping, fast forwarding, fast reversing, or otherwise circumventing the rendering of the predetermined content file 134 by preventing playback of selected content file 126.

For example, content insertion engine 140 also monitors the playback of predetermined content file 134. The content insertion engine 140 acquires a playback token, digital rights management (DRM) license, or the like in response to the ad playback event, which indicates that the advertisement has been rendered. The selected media content file 126 may then be decrypted with a key included with the playback token or DRM license. Those skilled in the art are familiar with several encryption/decryption schemes that are suitable for implementing aspects of the invention. Advantageously, aspects of the invention thus provide the benefits of higher quality video and the like associated with downloading media content while preventing the predetermined media content file 134 from being skipped or otherwise circumvented by the user during playback. In addition, locally caching the predetermined media content 134 and an associated token allows offline ad delivery and enforcement.

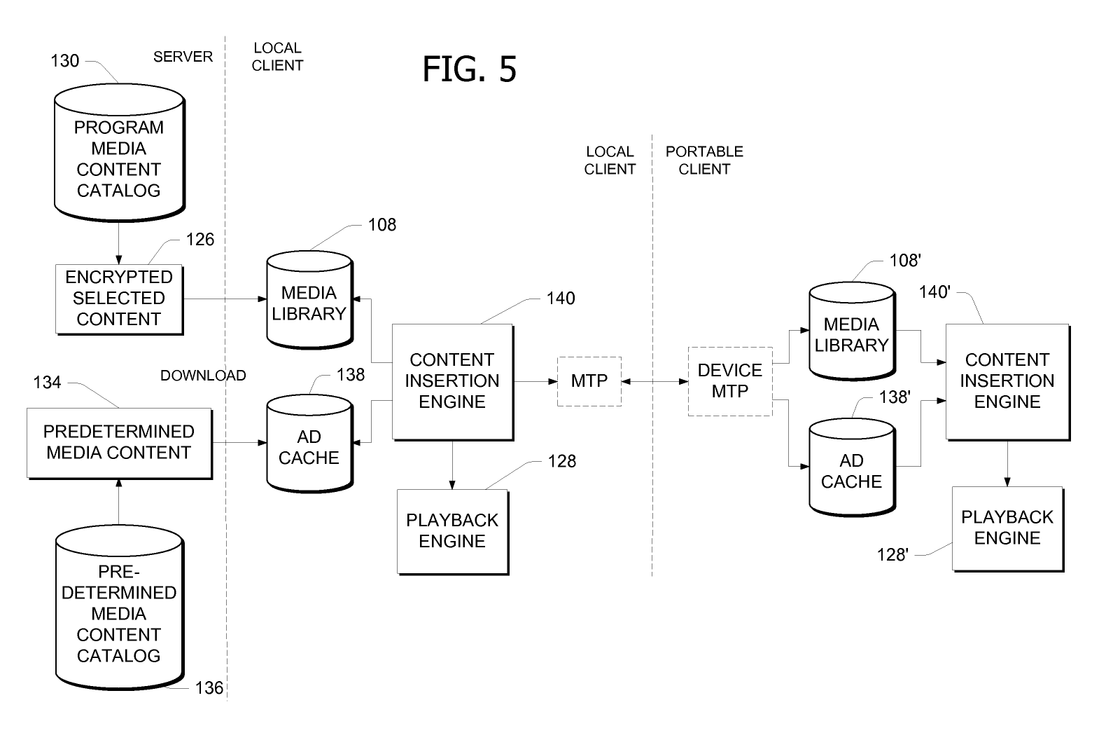

Although described in the context of implementing the content insertion engine 140 on computer 102 as a PC client, it is to be understood that the ad insertion and enforcement functionality described above may be performed by a portable client content insertion engine executed on portable device 112 (see FIG. 5).

As shown in FIG. 3, the portable device 112 supports the playlist 144, which is generated by the PC client (i.e., content insertion engine 140) and transferred to portable device 112 via MTP. In addition, computer 102 transfers one or more predetermined media content files 134, such as advertisements, as well as selected media content files 126 to portable device 112 for playback according to playlist 144. In this embodiment, computer 102 advantageously delivers device-friendly files to portable device 112.

The playlist 144, predetermined media content files 134, and selected program content 126 may be synchronized via MTP. In one instance, playlist 144 specifies which ads are to be rendered at what time. By restricting the transport controls available for use with playlist 144, the user is unable to circumvent the ads. Although the ads 134 and selected content 126 are associated with each other for playback, it is contemplated that the ad itself will not be visible to the user as an item in the playlist 144.

Referring further to FIG. 3, the illustrated embodiment provides an advertising infrastructure for inserting and tracking the playback of ads and other predetermined media content 134. Content insertion engine 140 inserts the predetermined media content files 134 at the beginning and/or during the course of content playback via, for example, playlist 144. In one embodiment, each content file 126 in the program media content catalog 130 has an ad engine associated with it. Each time a user selects media content 126 from the catalog 130, the ad engine's local plug-in (implemented, for example, by content insertion engine 140) is consulted for a list of pertinent ads. The ad plug-in maintains the local ad cache 138 and, if a cached ad is available, content insertion engine 140 calls for it to be rendered at the appropriate time. The successful playback of an ad is reported back to content insertion engine 140 by its local plug-in for use in ad tracking and reporting.

FIG. 5 illustrates an alternative embodiment of the invention in which portable device 112 implements an ad client in the form of content insertion engine 140′ that is analogous to content insertion engine 140. In this embodiment, content insertion engine 140′ on portable device 112 interacts with a local client (i.e., content insertion engine 140) on computer 102. The content insertion engine 140′ may also interact directly with ad servers associated with remote media service 116 via a network 104. The portable device 112, in this embodiment, maintains a cache 138′ containing predetermined media content files 134 in a device-friendly format. The contents of the cache 138′ may be refreshed through synchronization (or through direct Internet connection). The content insertion engine 140′ of portable device 112 in this embodiment contains ad business logic that may be updated through synchronization or via a direct network connection. In the embodiment of FIG. 5, an ad insertion component of content insertion engine 140′ is responsible for inserting ads during playback of the selected media content file 126. This component may likewise incorporate anti-tampering measures to prevent users from bypassing ads. For example, the portable client may enforce playback by disabling the transport controls of playback engine 128′ or simply requiring playback for a certain amount of time (e.g., the duration of an ad being played).

Referring further to FIG. 5, the illustrated embodiment provides an advertising infrastructure for inserting and tracking the playback of ads and other predetermined media content 134. Content insertion engine 140′, in this embodiment, inserts the predetermined media content files 134 at the beginning and/or during the course of content playback. An ad plug-in maintains the local ad cache 138′ and, if a cached ad is available, content insertion engine 140′ calls for it to be rendered at the appropriate time. The successful playback of an ad is reported back to content insertion engine 140′ by its local plug-in for use in ad tracking and reporting. It is to be understood that these functions may also be performed at the PC client (e.g., content insertion engine 140) and communicated to portable device 112 during synchronization.

Advantageously, DRM metering may be used to provide statistics relating to ad playback for tracking and reporting on ad delivery. For example, DRM metering keeps track of the number of plays on portable device 112 for each predetermined media content file 134. The portable device 112 keeps track of play counts via content insertion engine 140′ and uploads this information to content insertion engine 140 each time portable device 112 is synchronized.

It will be recognized by those skilled in the art that aspects of the invention may be implemented in a variety of software models, including an HTML application or a software add-in to an existing media player application 110. For example, the software add-in may provide a managed code plug-in that has access to an object model by which it can invoke media player functions. Likewise, the HTML application may provide access to media player functions via an object model. In the HTML example as executed on computer 102, a MediaCenter.PlayMediaEx( ) method allows playback or queuing of a media file and a MediaCenter.Experience object allows the application to query and set the play rate of media. In the add-in example as executed on computer 102, a HostControl.PlayMedia( ) method and a MediaProperties class perform similar functions. This control includes the ability to set the playback rate and receive events related to reaching the end of media.

As described above, the client enforces that advertisements play to completion. While the ad is playing back, the client operations run in the background and register an event (e.g., MediaCenter.onPlayStateChange on the PC client) that fires when the media being played (i.e., predetermined media content 134) changes state or rate. If the playback rate changes, the client resets the rate to 1 using, for example, an Experience.PlayRate property of media player application 110. If the playback position changes because the user has pressed fast forward or skip, the client resets the playback position to where it should have been at if the client had being playing at a playrate of 1. The PC client uses, for example, an Experience.MediaPosition property of media player application 110 to reset the playback position. In another embodiment, the client enforces playback by disabling the transport controls of media player application 110 or simply requiring playback for a certain amount of time. Those skilled in the art will recognize that media player application 110′ as executed on portable device 112 may be modified in a manner similar to these examples within the scope of various embodiments of the invention.

Each time an ad plays, playback engine 128 executes an ad enforcement state machine, for example, to report this event to content insertion engine 140. The insertion engine 140, in turn, periodically reports the ad playback to a web service (e.g. externally to remote media service 116) for use in rotating the ads, generating tracking statistics, etc. Upon completion of the playback of predetermined media content 134 (or a few seconds before it ends), the client acquires a token, for example, in response to the playback event and queues the selected media content 126 for playback using, for example, the MediaCenter.PlayMediaEx method.

The semantics described above may be enforced using, for example, a state machine that executes in the background while playback is in progress.

The exemplary operating environment illustrated in FIG. 1 includes a general purpose computing device (e.g., computing device 102) such as a computer executing computer-executable instructions. The computing device typically has at least some form of computer readable media. Computer readable media, which include both volatile and nonvolatile media, removable and non-removable media, may be any available medium that may be accessed by the general purpose computing device. By way of example and not limitation, computer readable media comprise computer storage media and communication media. Computer storage media include volatile and nonvolatile, removable and non-removable media implemented in any method or technology for storage of information such as computer readable instructions, data structures, program modules or other data.

Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media. The computing device includes or has access to computer storage media in the form of removable and/or non-removable, volatile and/or nonvolatile memory.

Moreover, embodiments of the invention may be implemented with computer-executable instructions organized into one or more computer-executable components or program modules. Generally, these components or modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The order of execution or performance of the methods illustrated and described herein is not essential, unless otherwise specified. That is, it is contemplated by the inventors that elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantages results attained.

As various changes could be made in the above constructions and methods without departing from the scope of embodiments of the invention, it is intended that all matter contained in the above description and shown in the accompanying drawings shall be interpreted as illustrative and not in a limiting sense.

What is claimed is:

1. A method of managing predetermined media content in connection with rendering selected media content on a portable computing device, said method comprising:
storing, in a memory area of a local computing device, one or more predetermined media files downloaded from a remote media service;
specifying, by a client application, at least one of the predetermined media files to be rendered in connection with a selected media file;
transferring the selected media file and the specified at least one of the predetermined media files from the local computing device to a portable computing device for rendering to a user; and
tracking, by the client application, a rendering of the at least one of the predetermined media content files on the portable computing device upon synchronization of the portable computing device to the local computing device.

2. The method of claim 1, wherein the client application comprises a content insertion engine executed on the local computing device, and further comprising generating, by the content insertion engine, a playlist containing the specified at least one of the predetermined media files and the selected media file, and wherein the portable computing device executes the playlist.

3. The method of claim 2, wherein transferring the selected media file and the specified at least one of the predetermined media files comprises transferring the playlist, the selected media content file, and the at least one of the predetermined media content files to the portable computing device according to a media transfer protocol.

4. The method of claim 2, further comprising refreshing the playlist upon synchronization of the portable computing device to the local computing device.

5. The method of claim 1, wherein the local computing device is coupled to a network, and further comprising reporting results of the tracking to the remote media service via the network.

6. The method of claim 1, further comprising specifying, by the client application, at least another one of the predetermined media files to be rendered in connection with the selected media file as a function of the tracking upon synchronization of the portable computing device to the local computing device.

7. The method of claim 1, wherein the client application comprises a content insertion engine executed on the portable computing device.

8. The method of claim 1, wherein storing the predetermined media files comprises storing the predetermined media files in a format adapted for rendering on the portable computing device.

9. The method of claim 1, further comprising transcoding the specified at least one of the predetermined media files for rendering on the portable computing device.

10. The method of claim 1, further comprising rendering, by a playback engine executed on the portable computing device, the specified at least one of the predetermined media files, and disabling one or more transport controls of the playback engine to enforce the rendering.

11. The method of claim 1, wherein the selected media file comprises a video program and the specified at least one of the predetermined media files comprises targeted advertising associated with the video program.

12. A method of managing predetermined media content in connection with rendering selected media content on a portable computing device, said method comprising:
storing, in a memory area of a local computing device, one or more predetermined media files downloaded from a remote media service;
transferring, according to a media transfer protocol, the predetermined media files from the local computing device to a portable computing device for rendering to a user;
storing, in a memory area of the portable computing device, the predetermined media files transferred to the portable computing device in a format adapted for rendering on the portable computing device; and
specifying, by a client application executed on the portable computing device, at least one of the predetermined media files to be rendered in connection with a selected media file.

13. The method of claim 12, further comprising tracking, by the client application executed on the portable computing device, a rendering of the specified at least one of the predetermined media content files, and reporting results of the tracking to a corresponding client application executed on the local computing device upon synchronization of the portable computing device to the local computing device.

14. The method of claim 13, wherein the local computing device is coupled to a network, and further comprising reporting, by the client application executed on the local computing device, the results of the tracking to the remote media service via the network.

15. The method of claim 13, further comprising specifying, by the client application executed on the portable computing device, at least another one of the predetermined media files to be rendered in connection with the selected media file as a function of the tracking upon synchronization of the portable computing device to the local computing device.

16. The method of claim 12, wherein transferring the predetermined media files comprises transcoding the predetermined media files into a format adapted for rendering on the portable computing device.

17. The method of claim 12, further comprising rendering, by a playback engine executed on the portable computing device, the specified at least one of the predetermined media files, and disabling one or more transport controls of the playback engine to enforce the rendering.

18. The method of claim 12, further comprising refreshing the predetermined media files stored in the memory area of the portable computing device upon synchronization of the portable computing device to the local computing device.

19. A media player system for rendering media content to a user, said system comprising:
a playback engine, executed on a portable computing device, for rendering media content to a user;
a media library storing at least one selected media file;
a cache storing one or more predetermined media files associated with the selected media file; and
a content insertion engine, executed on the portable computing device, for specifying which of the predetermined media files in the cache are to be rendered to the user via the playback engine in connection with the selected media file, said content insertion engine reporting a rendering of the specified at least one of the predetermined media files to another computing device upon synchronization of the portable computing device to the other computing device.

20. The media player system of claim 19, wherein the other computing device transfers the predetermined media files to the portable device according to a media transfer protocol.
